(19) United States
(12) Patent Application Publication
(10) Pub. No.: US 2008/0169970 A1
(43) Pub. Date: Jul. 17, 2008

(54) Multi-Platform Configurable Radar Device for Velocity Monitoring of Traffic and Other Moving Targets

(75) Inventors: David H. Woodcox, Fort Collins, CO (US); David W. Haile, Fort Collins, CO (US); Cory A. Peach, Fort Collins, CO (US); Kimble J. Smith, Loveland, CO (US)

Correspondence Address: PATENT LAW OFFICES OF RICK MARTIN, PC, PO BOX 1839, LONGMONT, CO, 80502, US

(73) Assignee: DECATUR ELECTRONICS, INC., Decatur, IL (US)

(21) Appl. No.: 11/622,247

(22) Filed: Jan. 11, 2007

(51) Int. Cl. G01S 13/58

(52) U.S. Cl. 342/113

(57) ABSTRACT

A Doppler shifted radar apparatus is disclosed for correct target identification with respect to surveillance of moving vehicles. More particularly, an improved system is disclosed that is fully programmable and configurable to a specific customer use such as a speed signal. One such configurable item is the output communications protocol. As an example, the customer can configure the speed limit, range, and/or direction of movement, standard or custom serial protocol and other unique features for a customer speed sign. Another feature is a real time clock to time stamp and store event data for future analysis. The apparatus also has a multi-voltage power supply for customer usage and versatility.

### FIELD OF THE INVENTION

The present invention relates generally to Doppler shifted radar and more specifically to target identification with respect to surveillance of moving vehicles. More particularly, it relates to an improved system that is fully programmable and configurable to a specific customer use. One such configurable item is the output communications protocol. As an example, the user can configure the speed limit, range, and/or direction of movement of a vehicle for a speed sign.

### BACKGROUND

One of the most common and useful tools in the enforcement of vehicular speed limit laws has been the real time posting of vehicle speeds on a sign. As such, speed monitoring and posting can be a reliable and affordable 24-hour, seven-day a week reinforcement. Speed posting is typically displayed at roadside battery powered signs, along with the actual speed limit. Solar power can also be used to boost the deployment time capabilities. Most also have AC Voltage plug in connectors for charging or continuous charging. Displays are typically LEDs with high output and wide viewing angles (25+ degrees). Speed signs typically can be pre-programmed to also post messages such as ‘You are exceeding the speed limit, please slow down’ etc. Such signs are easily transported to any location via a trailer module to any risk areas such as school zones, neighborhood throughways, construction zones, and high-accident areas.

These speed signs use Doppler radar, which is commonly known in the art whereby a microwave signal is transmitted to a vehicle (or other object) and then reflected off the vehicle. When a reflected signal is received back at the Doppler radar system, a change of frequency in the signal is proportional to the vehicle speed. That shift in signal frequency is known as the “Doppler Effect”. This shift in frequency is measured via received Doppler signals that are processed via a “Fast Fourier Transform” (FFT), and the resulting vehicle speed is calculated and displayed on the radar system.

Improvements are needed to existing prior art systems, such as the Decatur Technologies SI-2 and others that are used to monitor and enforce traffic. What is needed is an improved radar system that has smaller circuit boards for more unit compactness, allows user configurations and changes to configurations at any time, not just at power-up, provides on-chip Flash memory for improved reliability, provides a secure code base, wider range of temperature usage in extreme conditions, application and configuration software written in C language versus older assembly code type products, more hardware interface capability. For example addition of Controller Area Network (CAN) commonly used in newer vehicles and potential other future products and the addition of RS485 serial ports to allow monitoring from a central computer. What is also needed is a more hardened power supply, a real time clock for time stamping target speed data and for statistical analysis. Another item needed is user selectable operating bands (K or Kₐ), antennae choices, and providing for more data collection event storage capability.

The multi-platform configurable radar device (MPCRD) of the present invention can be compared to the prior art SI-2 apparatus offered by Decatur Industries. Table I below shows a functional comparison of both devices. Details of the MPCRD functions described in more detail herein.

TABLE I

| Function | SI-2 | MPCRD |
|---|---|---|
| Configurable Baud Rate | 9600 to 19.2k | 9600 to 115.2k |
| Antenna Frequency | K-band | K-band and Kₐ-band |
| Bands | | |
| Temperature Range | −20° C. to +70° C. | −40° C. to +85° C. |
| Serial Ports | RS-232 | RS-232, RS-485, CAN |
| Flash Memory | On-board Flash | DSP Internal Flash |
| Code | Assembly Code | C-language |
| Configurable Target | 200 mph max | 600 mph max |
| Range | | |
| Target speed parameters | MPH, KPH | MPH, KPH, MPS, FPS |
| Tracking | One object | Up to 10 Objects |
| DSP to ADC stability | N/A | Stabilized via |
| | | interrupt |
| Factory and conditional | N/A | Supported |
| user configuration | | |
| parameters for radar | | |
| control and target | | |
| speed tracking | | |
| Cosine Effect | Special Component | Accelerometer Module |
| Measurement | Board Assembly | on-board |
| Custom Protocol | N/A | Supported |
| Configurable Mode | Only at power up | Anytime after power-on |
| Real Time Clock | N/A | Supported |
| Event Tracking/ | N/A | Supported |
| Storage | | |
| Power Supply Voltage | 10.8 VDC–24 VDC | 8.5 VDC–28 VDC |
| Range | | |
| RFI detection | Digital | Digital and/or Analog |
| Antenna Type | Horn lens | Horn lens or micro- |
| | | strip array |

The present invention provides improvements to all of the aforementioned needs while reducing physical size. It also provides the ability for multi-platform usage in other applications that will be described herein.

The foregoing example of the related art and limitations related therewith are intended to be illustrative and not exclusive. Other limitations of the related art will become apparent to those of skill in the art upon a reading of the specification and a study of the drawings.

### SUMMARY

One aspect of the present invention is to provide a radar device that has a user configurable platform whereby users can configure parameters such as the speed limit, detection range, direction, amplitude (size of objects), and output communications protocol.

Another aspect of the present invention is to provide a multi-platform apparatus that can detect parameters for a variety of objects including, but not limited to, vehicles, sports balls, projectiles, water flow, etc.

Still another aspect of the present invention is to provide for a data collection capability of the various parameters monitored.

Yet another aspect of the present invention is to provide a hardened power supply having a wide range of DC voltage inputs, Radio Frequency Interference (RFI) immunization, lightning protection, built in hysteresis for voltage spike protection and audio amplification capability.

Another aspect of the present invention is to provide factory and conditional user configuration parameters to control radar and target speed tracking operation. A partial list of these parameters is shown below in Table II.

Another aspect of the present invention, an alternate embodiment, is to incorporate two or more continuous transmitting frequencies to provide for correct identification multiple target speeds and ranges.

Other aspects of this invention will appear from the following description and appended claims, reference being made to the accompanying drawings forming a part of this specification wherein like reference characters designate corresponding parts in the several views.

The multi-platform configurable radar device (MPCRD) of the present invention is basically composed of a conventional RF microwave section with a horn-lens antenna or a compact micro-strip array antenna, a transceiver, a Digital Signal Processing (DSP) motherboard, a power supply and hardware communication interfaces. The MPCRD also contains a software platform to allow configuration to user requirements. The MPCRD will be explained below in detail. The most common application for the MPCRD would be connecting it to a variety of roadside displays to display vehicle speeds. This can allow a city to use existing inventory of signs, all upgraded to the improved MPCDR. Other applications would include, but not be limited to tracking speeds of projectiles, sport balls, and water current flows in a stream.

An alternate embodiment of the present invention incorporates the ability to transmit two or more continuous frequencies to enable multiple target speeds and ranges to be specified. U.S. Pat. No. 6,798,374 filed Nov. 5, 2002 and titled ‘Traffic surveillance radar using ranging for accurate target identification’ and pending application Ser. No. 11/468,099 dated Aug. 29, 2006 and titled ‘Traffic Surveillance Radar Using Ranging For Accurate Target Identification’ are both incorporated herein by reference, especially FIGS. 1, 2, 3, 8 of U.S. Pat. No. 6,798,374 and FIGS. 1, 2, 3, 4 of pending application Ser. No. 11/468,099.

The present invention MPCRD provides a compact radar device that provides:
1. A software configurable platform for:
   Serial Protocol selection;
   K/Kₐ frequency band operation selection; and
   Direction, Speed, Upper/Lower Limit, Range selection.
2. Manual hardware selection for Serial I/O (i.e. RS-232, RS-485, CAN) to be used;
3. Antenna type selection; horn-lens antenna or a compact micro-strip array antenna;
4. Power Supply having hardened capabilities (i.e. lightning protection, RFI detection, built-in hysteresis, audio amp capability) and capable of being plugged into wide range of DC voltage sources.
5. A DSP with on-chip flash memory for higher reliability and a secure code base.
6. A DSP with event storage capabilities.
7. Audio output capability.
8. The ability to operate in a wide temperature range of approximately −40 C to 85 C (−90 F to +185 F).
9. Controller Area Network (CAN) capability for connection to new vehicles and other future products.
10. A real time clock (RTC) to record and transmit the time a target speed was displayed.
11. On-board memory for event storage and statistical analysis.

The MPCRD of the present invention provides user configurable platform whereby users can configure parameters such as the speed limit, detection range, direction, amplitude (size of objects), and output communications protocol. It contains non-volatile flash memory integrated into a digital signal processor (DSP) chip that allows customers to have different operating parameters, which they can configure. One of the configurable items is the output communications protocol, which users typically have as a specific communication format unique to their use. The preferred embodiment of the present invention is for use with speed signs that show a vehicle speed along roads and highways. However, the MPCRD is capable of multi-platform applications to detect parameters for a variety of objects including, but not limited to, vehicles, sports balls, projectiles, water or material flow, etc. The MPCRD provides for a data collection capability of the various parameters monitored. Its hardened power supply accepts a wide range of DC voltage inputs, and provides Radio Frequency Interference (RFI) immunization, lightning protection, built in hysteresis for voltage spike protection and audio amplification capability.

Depending on end user requirements, the MPCRD operates in either the Ka-band (33.4 GHz to 36.0 GHz) with Doppler shifts of about 105.9 Hz per mile per hour (centered on the band—35.5 GHz) or the K-band (24.050 GHz to 24.250 GHz) with Doppler shifts of about 72.038 Hz per mile per hour (centered on the band—24.150 GHz).

The MPCRD is composed of the basic following items:
RF microwave section with a horn-lens antenna or a compact micro-strip array antenna;
DSP motherboard;
Power supply board;
Optional audio board
Hardware communication interfaces; and
Software to allow configurable applications.

The above will be explained in more detail in the figures below.

The unique features of the MPCRD are:
Fully configurable by the factory or at the user site. It can be configured to output various serial formats as well as to operate in various modes;
The DSP chip uses built in flash memory for program execution and storage of customer parameters. This results in a compact size;
The MPCRD power supply will interface with various customer electrical systems with wide supply voltages;
The MPCRD has a configuration program that easily allows users or the manufacturer to set unique operation functions.

The present invention also provides factory and conditional user configuration parameters to control radar and vehicle speed tracking operation. A partial list of these parameters follows in Table II.

TABLE II

| Command | Data Format and Description |
|---|---|
| Display Vehicles: <bool> | Puts the number of vehicles seen in the |
| | present field of radar in the location |
| | normally reserved for the Fastest speed. |
| | This only affects the view from the LCD |
| | display. |
| Display Fractional: | Displays present speed with tenths, |
| <bool> | hundredths, and thousandths places in the |
| | location normally reserved for the |
| | Fastest speed. This only affects the view |
| | from the LCD display. |
| Noise Floor: <float> | Sets the level in the FFT Output Array |
| | for both ADC channels below which speed |
| | information is not calculated. The valid |
| | range is 0 to 2147483647. |
| Left Noise Floor: <float> | Same as above, but only for the Left |
| | channel. |
| Right Noise Floor: | Same as above, but only for the Right |
| <float> | channel. |
| Sample Frequency Divider: | Divides the sample frequency by this |
| <int> | number. The default is 4 to result in a |
| | normal implementation. Dividing the |
| | sampling frequency allows for more |
| | resolution and more stable readings at |
| | lower speeds. The valid range is power of |
| | 2 integer in from 1 to 1024. |
| | As an example, the following maximum |
| | speeds relate to these settings: |
| | 1 - 630 mph |
| | 2 - 315 mph |
| | 4 - 155 mph (default) |
| | 8 - 75 mph |
| Lock Delta: <float> | If the present speed and the displayed |
| | speed are within this speed of each |
| | other, the speed stays in the Lock mode. |
| Loose K: <float> | The filtering value on the present speed |
| | used within the speed locking algorithm |
| | when the speed display is not Locked. |
| Tight K: <float> | The filtering value on the present speed |
| | used within the speed locking algorithm |
| | when the speed display is Locked. |
| Delta Lock Count: <int> | The number of cycles when the speed is |
| | stable within the Lock Delta before it is |
| | locked. |
| Speed Increase Counter: | The number of cycles that the speed has |
| <int> | increased before the speed lock algorithm |
| | will request to transition to the lock |
| | state. |

Although the primary embodiment of the present invention is to detect a single target speed, based on the strongest received signal, an alternate embodiment can incorporate two or more continuous transmitting frequencies to provide for correct identification multiple target speeds and ranges (i.e. U.S. Pat. No. 6,798,374).

### BRIEF DESCRIPTION OF THE DRAWINGS

FIG. 1 is an overall view of the MPCRD (the present invention) showing several potential uses.

FIG. 2 is a perspective exploded view of the MPCRD components.

FIG. 3 is a side view of the MPCRD with the internal boards and radar cone removed from the case.

FIG. 4 is a block diagram of the DSP motherboard shown in FIG. 2.

FIG. 5 is a block diagram of the power supply board shown in FIG. 2.

FIG. 6 is a flow chart diagram of the configuration program.

FIG. 7 is a sample configuration screen for the MPCRD configuration process.

FIG. 8 is a basic application flowchart for the MPCRD software.

FIG. 8A is a flow chart showing further details of FFT data processing tracking steps shown in FIG. 8.

FIG. 8B is a flow chart of the ‘Process Commands’ step shown in FIG. 8.

Before explaining the disclosed embodiment of the present invention in detail, it is to be understood that the invention is not limited in its application to the details of the particular arrangement shown, since the invention is capable of other embodiments. Also, the terminology used herein is for the purpose of description and not of limitation.

### DETAILED DESCRIPTION OF THE DRAWINGS

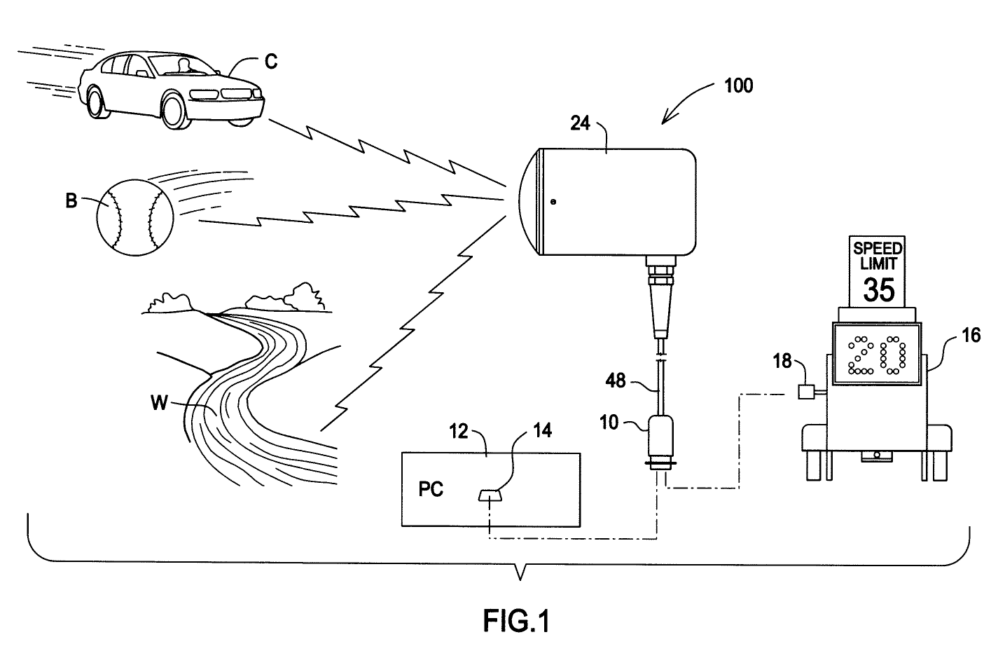

FIG. 1 is an overall view of the MPCRD showing several potential uses. MPCRD 100 is shown with serial power/communications cable 48 having output power/communications connector 10 for connection to either a PC (personal computer) 12 at its serial input connector 14 or connected to a speed sign 16 at its serial input connector 18. MPCRD 100 can be targeted at a variety of applications. The preferred embodiment would be to target vehicle C and connected to speed sign 16 to display the moving vehicle C speed. Other applications could be to connect to PC 12 (or other portable device) and target vehicle C speed, ball B speed, current W flow speed or other applications not specifically shown. Case 24 is an environmentally protected case.

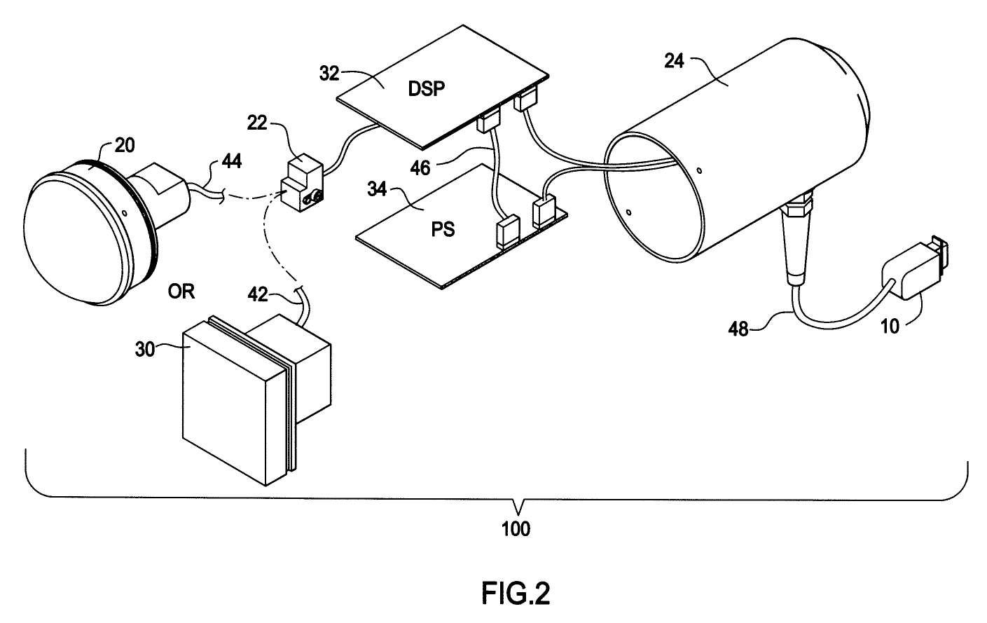

FIG. 2 is a perspective exploded view of the MPCRD 100 with its components to show both assembly and interconnectivity. Horn lens antenna 20 attaches to transceiver 22 via connection 44. Transceiver 22 connects to DSP motherboard 32, which in turn, is connected to power supply board 34 and power/communication cable 48 for serial communication. Power/communication cable 48 supplies system power via connecting to PS board 34 along with supplying the input serial protocol to DSP motherboard 32. Serial power/communications connector 10 on power/communication cable 48 is a standard 9-pin serial interface. The antenna used can be a horn lens antenna 20 or can be a flat micro-strip array antenna 30, which would also connect to transceiver 22 via connection 42. Case 24 is shown to accept horn lens antenna 20, which would have an O-ring for seal-ability. If flat micro-strip array antenna 30 were used, then an appropriate form factor case (not shown) would be used, thereby providing a housing to fit on a flat sign surface or other flat surface. The compact size of each component provides a compact MPCRD 100 that can be easily held or mounted.

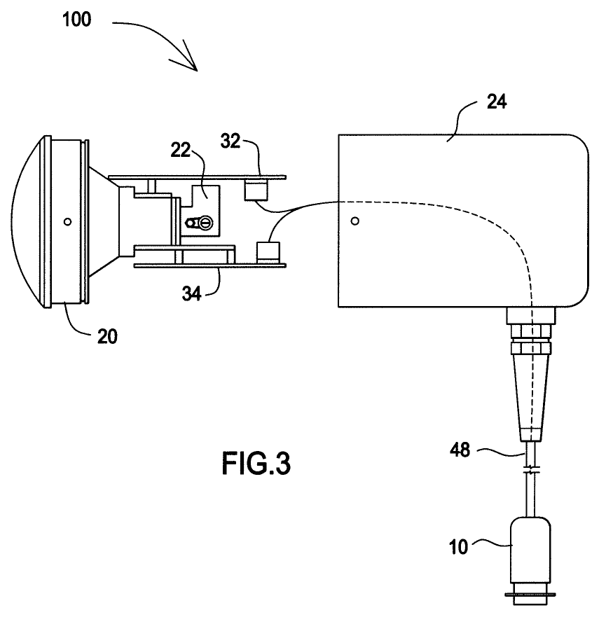

FIG. 3 is a side view of the MPCRD 100 with the internal boards and radar cone 20 removed from the case. Transceiver 22, DSP motherboard 32, and power supply board 34 form a sub-assembly that would fit inside of case 24. Power/communications cable 48 would attach to the sub-assembly and exit case 24 through a grommet seal.

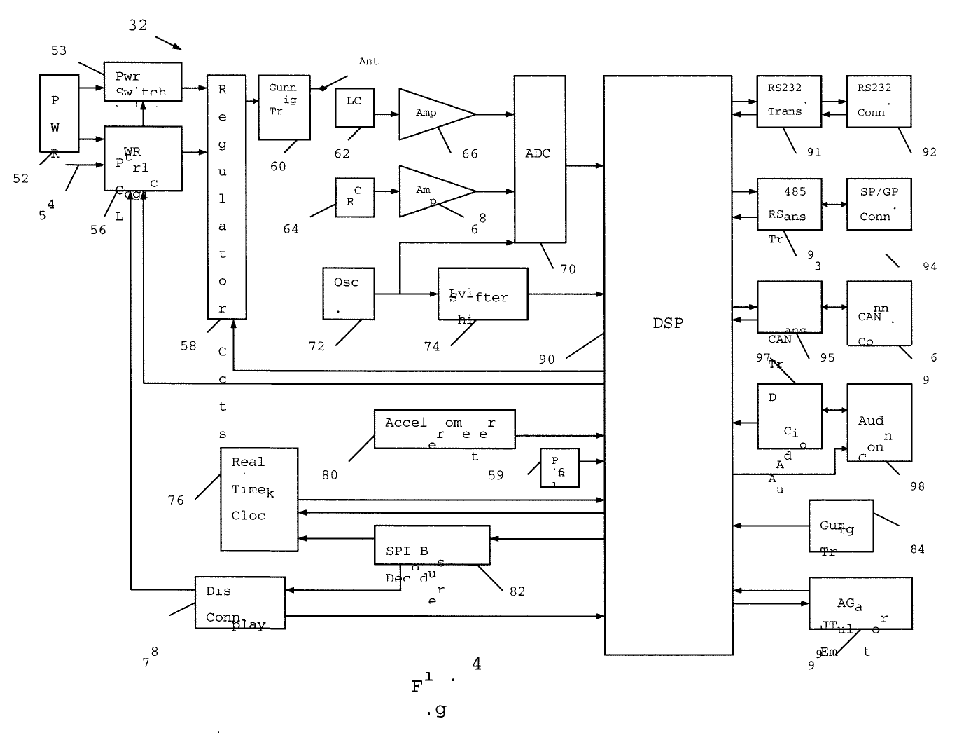

FIG. 4 is a block diagram of the DSP motherboard 32 of the present invention. Power input 52 from power supply board 34 (ref. FIG. 2) accepts and outputs five lines. A positive DC voltage in the range of about +6.4 VDC to +10 VDC referenced to ground, a power enable allowing power to the rest of the electronics to be enabled, and a low battery input that can be used as a low battery indicator. The battery low input is connected to the DSP chip and could be used to indicate a low battery condition. The fifth pin is the RFI detect pin. It is connected to the DSP and could be used as an RFI detected indicator. Power input circuitry 52 also contains a choke that attenuates high frequency noise, a clamp for transient voltage spikes on the power input and a reverse battery protection diode. Power switch 53 is controlled by the input power enable signal. Whenever the power enable signal is asserted (low), power will be applied to the on-board voltage regulators circuit 58, and the MPCRD system will be powered on. Gunn trigger 60 is connected to regulator circuits 58 and to the antenna. The power enable signal can be asserted from four sources; the power enable signal itself; a power-on signal from the serial power/communications connector (ref. FIG. 2, connector 10); a power soft key input from the user-display 78; and a power-on hold from the DSP 90 used to enable or disable power under software control that will assure the system will continue to have power when or if the direct power enable or the power-on signal from the serial connector are de-asserted.

Regulator circuits 58 consist of various voltage regulators including a Gunn diode regulator that is an adjustable linear regulator used to power the Gunn diode in the radar antenna. The Gunn diode regulator has an enable from DSP 90 that allows the output voltage to be turned on or off under program control. Regulator circuits 58 also consist of 1.9 VDC switching regulator, which powers the core of DSP 90 and the oscillator and a clock level-shifter circuit. Regulator circuits 58 also contain a 3.3 VDC switching regulator, which powers an I/O ring on DSP 90. Power supply source PSS 57 inputs regulator circuits 58 into a power supervisor circuit to monitor the 1.9 VDC, 3.3 VDC, and 5 VDC supply voltages. The 3.3 VDC supply will activate prior to the 1.9 VDC supply. A +5 VDC regulator is enabled after both switching regulators are functioning. Three analog supplies are also provided. A +3 VA and a +1 VA are used by DSP 90 analog-to-digital converter and a +5 VA is used by the amplifier circuits and the analog to digital converter. All on-board power supplies provide power supply inputs 59 to DSP 90 internal ADC. Since the maximum common-mode voltage input to the DSP ADC is 3.0 V, the on-board power supply voltages are scaled using a resistor voltage divider.

DSP 90 is the main controller for the MPCRD 100 system. DSP 90 could be a Texas Instrument® micro-controller TMS320F2811 that is referenced by way of example and not of limitation. As such, DSP 90 has internal features such as flash memory, internal ROM, on-chip PLL, a 16-channel 12-bit ADC with on-chip reference, several interfaces to serial protocols such as Serial Peripheral Interface (SPI), Multi-channeled Buffered Serial Port (McBSP), Controller Area Network (CAN), Serial Communications Interface (SCI) and other features not specifically mentioned herein. It is used to perform functions such as:
Configuration of off-chip peripherals;
Enables/disables the GUNN diode power;
Enables/disables RS-232, RS-485, and CAN (Control Area Network) interfaces chips and communicates with external devices over these interfaces;
Monitors system power supplies and on-board power supply voltages;
Monitors input from the accelerometer 80;
Receives digitized Doppler signals;
Communicates with the real time clock 76 and user display 78;
Controls the power hold signal that enables system power; and
Monitors the state of external switches such as power and application specific keypad inputs.

DSP 90 is typically run at 122.88 MHz (using a 24.576 MHz oscillator 72 with a 5× multiplier) in order to get an integer number of cycles per second, although there are other valid frequencies and does not interfere with police or commercial bands. System oscillator 72 inputs analog-to-digital converter (ADC) 70 and level-shifter 74. Level-shifter 74 shifts a +3.3 VDC to a +1.9 VDC into DSP 90. The use of an external oscillator provides the ability to drive both the ADC and the DSP; has a smaller footprint than a crystal alone; and provides more reliability to the circuitry.

Left Channel antenna signal 62 and right channel antenna signal 64 from the radar antenna enter DSP motherboard 32 through a two-position mounting hole. Amplifiers 66, 68 are low-noise low-distortion amplifiers.

Analog-to-Digital (ADC) converter 70 is used to digitize the Doppler signals from the output of the amplifier circuits 66, 68 for processing by DSP 90 to calculate and display target speed. Typical sampling rates are in the area of 96 KHz. ADC 70 connects to DSP 90 via the McBSP interface which is a synchronous clocked serial interface and can be run at about 6.114 MHz (24.576 MHz/4).

Serial ports provide external communication. Configuration software will enable the respective port depending on user configuration requirements. RS-232 transceiver 91 consists of two transmit and two receiver channels I/O connected to RS-232 connector 92. RS-485 transceiver 93 connects to serial port/general purpose I/O connector 94, which can be configured as a pure logic-level serial port or a general purpose I/O. CAN transceiver 95 connects to CAN connector 96 and allows the MPCRD to connect to systems (usually automobiles) that communicate via the CAN bus.

A PC-based configuration can send commands to the MPCRD over the serial input. Commands include:
configuration commands;
speed lock element commands that control how the MCPRD locks on a target's speed;
development support commands, which are only used by the developer or engineering support;
identification commands sent to the control resulting in data returned from the control;
error reporting codes such as power supply monitoring errors, non-volatile memory storage problems, etc; and
test support commands which are used during testing only.

Real time clock (RTC) 76 has a battery backup. RTC 76 allows the MPCRD to timestamp data and thus be used as a traffic data logger. Data is retained even when the primary power is removed. All signals to/from RTC 76 are diode isolated, so that the backup battery (i.e. lithium) will not try to power other circuitry. Typical life of this type of backup battery is in the range of 77 k hours (8.75 years). Serial peripheral interface bus decoder 82 decodes bus outputs from DSP 90 to either RTC 76 or user-display connector 78 as appropriate.

Accelerometer 80 is used to compensate speed measurements when the target direction and the radar are not co-linear. This effect is commonly known as the cosine effect. Uncompensated velocity will be less than actual by a scaling factor equal to the cosine of the angle θ between the radar and the target. Actual velocity can then be calculated as ‘measured velocity’/‘cosine θ’. In the MPCRD, θ is calculated by the on-board accelerometer 80 (for example the ADXL203E). For example the ADXL203E is capable of measuring up to 1.7 g. An accelerometer is usually associated with acceleration due to motion, changing velocity. However, it can also use the force of gravity (g) as an input vector to determine orientation in space. The specification for ADXL203E is 1V per g when using a +5V supply. Using +3.3V supply for the MPCRD to power accelerometer 80, and since output voltage is ratiometric with supply voltage; the output voltage of accelerometer 80 is 0.65V per g. Using a +3.3V power source, when the accelerometer 80 is perpendicular to the force of gravity, i.e. parallel to the Earth's surface, the output voltage, for that axis is approximately +1.65 V which corresponds to 0 g. When the accelerometer 80 axis is parallel to the force of gravity, i.e. perpendicular to the Earth's surface, the output voltage, for that axis, is approximately 0.5V (at 1.7 g) or 2.8 V (at −1.7 g). The MPCRD should never experience more than 1 g in normal use. Therefore the output voltages for either axis of accelerometer 80 should range between approximately 1.0V (at +1 g) and 2.3 V (at −1 g). The value of theta (θ) is then calculated using the measured accelerometer voltage as follows:

$$θ = ARCSIN ( \frac{voltage for 0 g - measured accelerometer voltage}{Voltage for 1 g} )$$

$$θ = ARCSIN ( \frac{1.65 - measured accelerometer voltage}{0.65} )$$

Careful inspection of the above equation reveals that the argument to the ARCSIN function must be between +1.0 and −1.0. Any value of the ARCSIN argument that exceeds the magnitude of 1.0 will cause an error in the computation. This argument will only be outside the valid range when the measured accelerometer voltage is less than 1.0V or greater than 2.3V. This could occur due to shock, vibration or some other acceleration that adds to the gravitational acceleration. Therefore, it is essential that provisions are made to detect an over-range condition and default it to the valid value of ARCSIN argument.

The DAC audio converter 97 is used to create an audio signal that corresponds to the measured speed and is connected to output DAC connector 98. Audio output can thus be made available to a user to, for example, produce sound signifying the target speed.

JTAG/Emulator connector 99 is used to interface DSP 90 to an external JTAG chain or to the software development debugger.

User-display connector 78 is generally used to interface DSP motherboard 32 to a small LCD/Keypad module. This connector also has direct connections to DSP 90 I/O pins that are generally used to detect key presses. However any synchronous clocked serial peripheral device could be connect via this connector.

The input of gun trigger 84 is a single pole, single throw pushbutton switch that connects to a two pin connector. The output of gun trigger 84 is a quasi-debounced (low pass filtered) signal connecting to an input pin on DSP 90. When the gun trigger is open (not pressed), the output signal is pulled to a high logic state. When the gun trigger is closed (pressed), a short time later (after an RC delay), the signal is at ground potential. DSP 90 will see the input and respond appropriately.

Other features of the DSP motherboard 32 include allowing particular hardware configurations to be identified by firmware. For example, if a particular resistor has been assembled on the printed circuit board, then the associated I/O pin will read as a logic-low, or a logic-high if not assembled. The DSP also has a built-in boot loader ROM that allows transferring of application code to the DSO in a variety of interfaces such as the RS-232 communications port. Holding four I/O pins at particular levels when power is supplied to the DSP activates the boot loader. In the application of the present invention this feature is only used for initial boot code as one of the first steps after assembly. An internal program uses a config.exe program to download the application and configuration data via use of the initial boot code without need to activate the aforementioned four I/O pins.

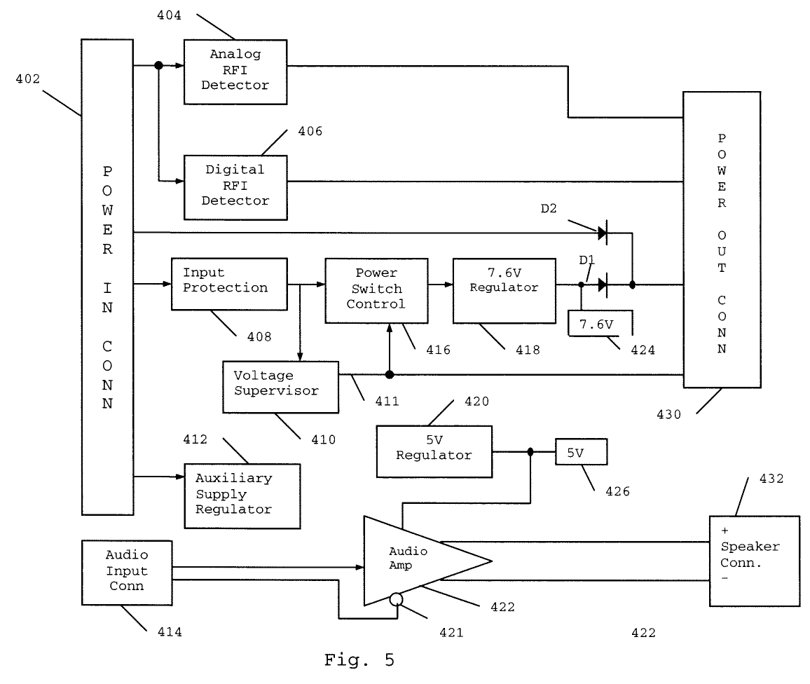

FIG. 5 is a block diagram of the power supply board 34 shown in FIG. 2. All power enters via power in connector 402. Inputs include:
1. A RFI input signal;
2. The negative side of the input battery supply voltage or system reference voltage;
3. The positive side of the input battery supply voltage ranging from +7.2 VDC to +9.6 VDC.
4. The positive side of the input power supply voltage ranging from +8.5 VDC to +28 VDC referenced to the negative side of the input power supply voltage;
5. The negative side of the input power supply voltage;
6. A +12.2 VDC output of the auxiliary power regulator used to power external auxiliary devices;
7. The negative side of the input auxiliary supply or auxiliary power reference voltage;
8. The positive side of the input auxiliary supply voltage ranging from +13 VDC to +20 VDC.

Voltage supervisor 410 accepts valid input voltages in the range of +8.5 VDC to +28 VDC. Voltage supervisor 410 ensures that the power supply circuitry does not attempt to power up unless the input voltage is valid or a minimum of 8.5 VDC. A hysteresis voltage is set at about 2.5 VDC, thus no reset signal will be asserted unless the voltage goes below 6.0 VDC. A power enable output signal 411 is used for control.

Power switch control 416 is controlled by the output of voltage supervisor 410. Whenever the power enable output signal is asserted, power will be applied to the on-board voltage regulator and the system will power-on.

There are two RF detectors on the power supply board; analog RFI detector 404 and digital RFI detector 406. The power supply voltage for the RF detector circuits is derived from the main 7.2 VDC supply and the +5 VDC audio amplifier supply. Typically only one or the other of these circuits would be assembled on power supply board 34. The analog RFI detector 404 has an output that is frequency selective and a frequency threshold is typically set to 15.15 MHz with a 3 dB cutoff frequency of 23.4 KHz. Digital RFI detector 406 will have an output low (GND) when RF energy is sufficient to hamper accurate speed readings.

Auxiliary supply regulator 412 is a low dropout (0.5V max at 3 A) adjustable linear regulator used to power an off-board device, usually a printer, and uses the auxiliary power supply input regulating the output to 12.2 VDC nominal.

7.6 VDC switching regulator 418 (i.e. Linear Technology LTC1778 integrated circuit) steps its input voltage down to +7.6 VDC 424. It typically has a wide range of input voltages (4V to 36V) and features resistor programmable output voltages, adjustable on-time, adjustable operating frequency, adjustable current limit, and programmable soft-start.

+5V regulator 420 provides +5V output 426 is used to power the audio power amplifier 422 and optionally the RF detectors 404, 406. Audio power amplifier 422 receives a low-level audio signal from audio connector 414 and amplifies it. Audio connector also provides an enable input 421 to the amplifier. Outputs of audio amplifier 422 provide an amplified signal to the ‘+’ and to the ‘−’ side of a speaker via speaker connector 432. Audio signals can be used to report real-time target speed, for example reporting speed to a baseball pitcher during warm-up or to give a policeman real-time audio feedback when using the MPCRD in a hand-held radar gun application.

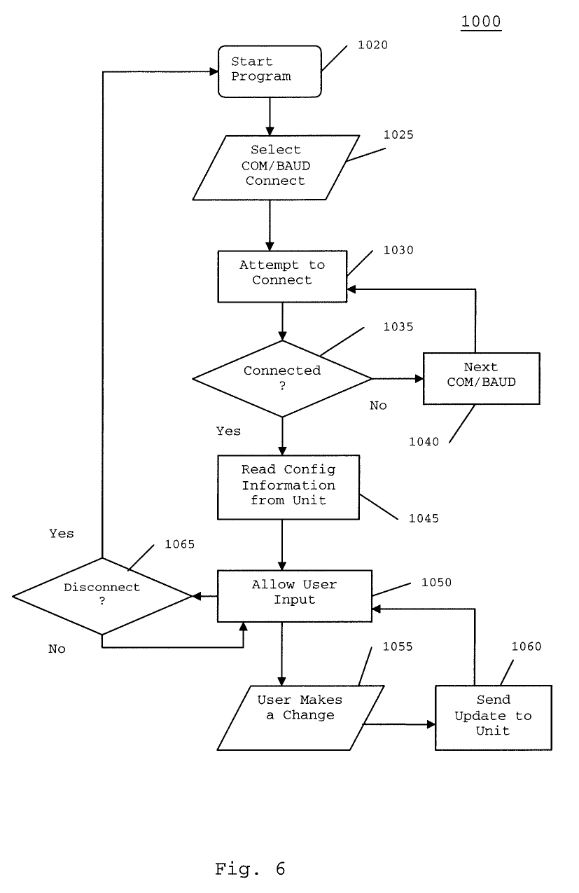

FIG. 6 is a flow chart diagram 1000 of the configuration program. In order to configure the MPCRD the following would be required:
The MPCRD 100 itself;
The power/communications cable 48 attached;
A PC with a usable RS-232 serial port or USB-to-RS232 adapter;
RS-232 cable to connect between the power/communications cable 48 and the PC. The cable is a 9-pin RS-232 cable with a male connector on one end and female connector on the other;
The MPCRD configuration program; and
A 12 VDC power supply.

The configuration program features the following:
1. Auto Baud—the configuration program will attempt to connect at the user specified baud and port, if it is unable to connect, it will search through standard combinations of baud rates and ports to try to find the unit.
2. Programming Tool—there is a built-in tool that allows the reprogramming of the MPCRD using a supplied file.
3. Password Protected—some of the higher functions are accessed through a password protected screen box. Various levels of protection can be set.
4. One Time Serial Number Programming—if the serial number is set to anything besides ‘0’ the program will not allow someone to change it. If it is ‘0’ then the serial number can be changed.
5. Instant Feedback—the output of the MPCRD is shown in an output display window in the program.

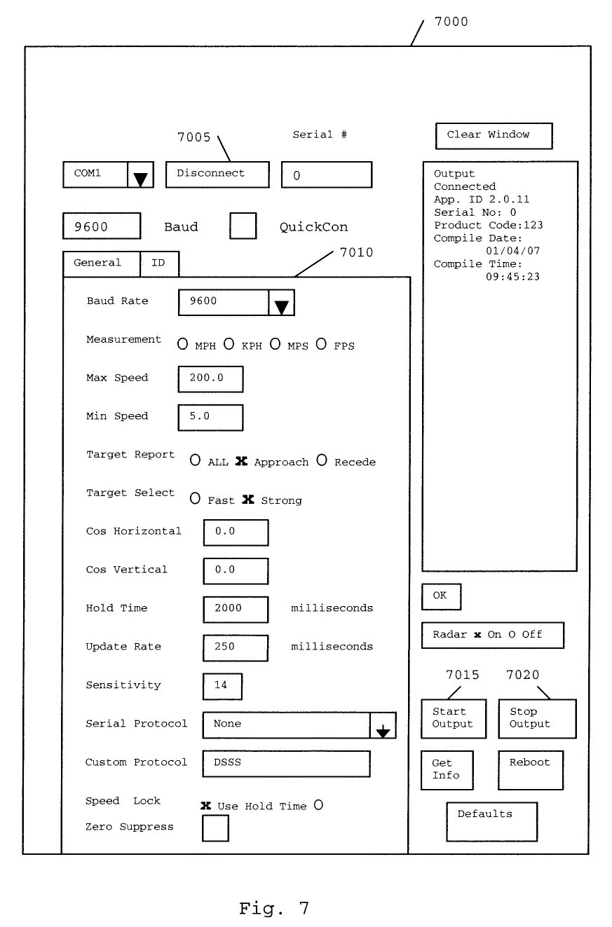

Referring now to both FIGS. 6, 7, the flow chart 1000 of FIG. 6 depicts the configuration steps and FIG. 7 is a sample configuration screen for the MPCRD configuration process. After applying the 12V power to the MPCRD (pin one on power/communications cable 48), the program will start as shown in step 1020. A screen window 7000, an example as shown in FIG. 7, will appear containing a ‘connect/disconnect button’ 7005 near the top of the window. An inner screen window 7010 would also contain the configuration parameters described below, with the ability of users to change the parameters, and/or buttons as follows:
1. Baud Rate—the baud rate can be 1200, 2400, 4800, 19.2K, 38.4 k, 57,6 k or 115.2 k bits per second. Typical use is 8 bits, no parity, and one stop bit for its serial port configuration;
2. Measurement parameter for target—miles per hour (MPH) or kilometers per hour (KPH) or meters per second (MPS) or feet per second (FPS) etc.;
3. Max. speed to be reported/displayed;
4. Min. speed to be reported/displayed;
5. Target Report—targets moving towards or away from the MPCRD (All), towards the MPCRD (Approach) or conversely away from the MPCRD (Recede);
6. Target Select—Fast or strong signal—a select of strong is the default, whereby changing to ‘fast’ will report the fastest vehicle within the MPCRD range;
7. Cos Horizontal—for installations where the MPCRD is at a significant angle from the road, the horizontal angle can be configured;
8. Cos Vertical—for bridge-type installations or where the MPCRD is above the target, the vertical angle can be entered to ensure that the MPCRD calculates the correct target speeds;
9. Speed lock—if set then a ‘Hold Time’ can be entered which indicates the time the target speed is displayed after the target moves out of range;
10. Continuous Update—if selected instead of ‘Speed Lock’, then the ‘Hold Time’ has no effect;
11. Sensitivity—a default sensitivity is set to work in most application installations. The sensitivity can be increased for further range or decreased for closer range target detection. If the sensitivity is too high for a given location, the display may become erratic. If the sensitivity is too low, the MPCRD may take too long to lock onto and display a target speed;
12. Serial Protocol—a serial protocol uses a <D>[SSS.]<cr> where <D> is a direction character that is “+” for targets coming towards the MPCRD, “−” for targets going away, and “?” when the direction cannot be determined. [S] represents the displayed speed. If a period is within the square brackets, it is a decimal point. The <cr> signifies the end of the outgoing message. Other custom protocols can be used. An ‘Update Rate’ can be set for sending the message format every ‘Update Rate’ milliseconds (as low as 50 milliseconds with increments of 50 ms).
13. Zero Suppress—when this value is selected, no information will be sent unless a target is detected.

Start Output/Stop Output buttons 7015, 7020 also appear within screen window 7000. These buttons are used to start and stop the continuously updated serial protocol.

Once the configuration program is started, step 1020 the user would press the screen ‘connect’, step 1025, and the configuration program will attempt to connect, step 1030. Then it would query the RS232 line to see if the MPCRD is connected, step 1035. A default Baud rate would be 9600 bps. If no connection is detected, step 1040, a response of ‘Unable to Connect’ would be given and a return to step 1030 would be made. If a connection problem is detected the screen will update with screen information to depict the present configuration of the MPCRD showing values that are in use. If a successful connection is made, step 1045 would read the configuration information from the unit and display the parameters. Then, in step 1050, user inputs would be allowed and continuous monitoring of user disconnect, step 1065, are put into place. In step 1055, the user would make any changes. In step 1060 the program would send and store any changes to the MPCRD unit in the non-volatile memory. With the exception of the baud rate, all changes occur immediately and do not require a reboot for the MPCRD to become operational. Typical interrupts would include; reading and displaying data from the COM, closing the program or exiting; and programming from a file.

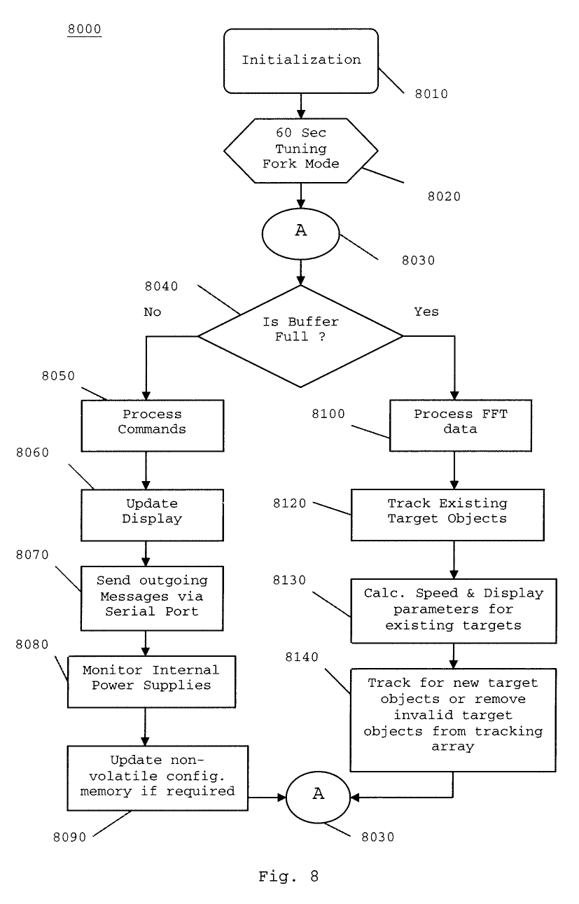

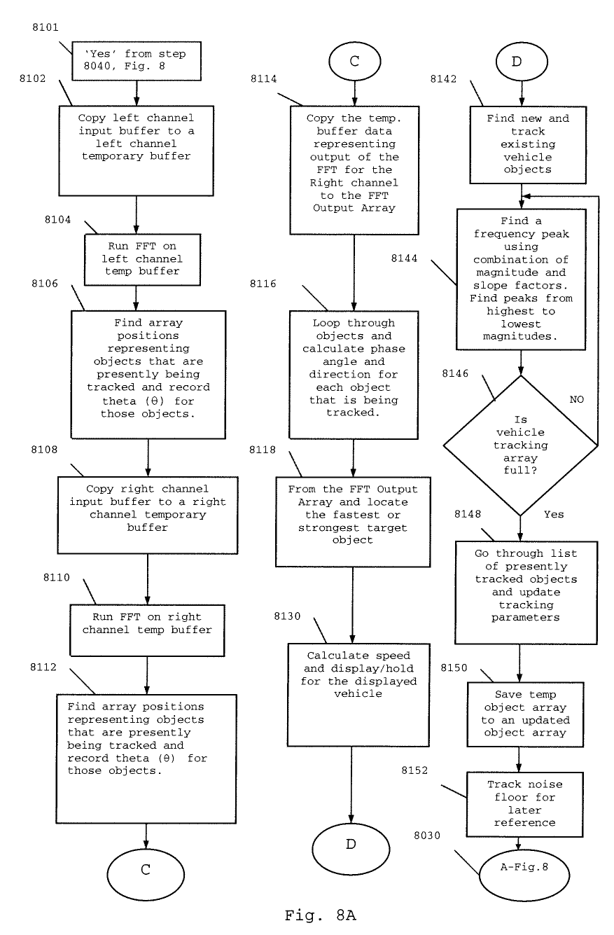

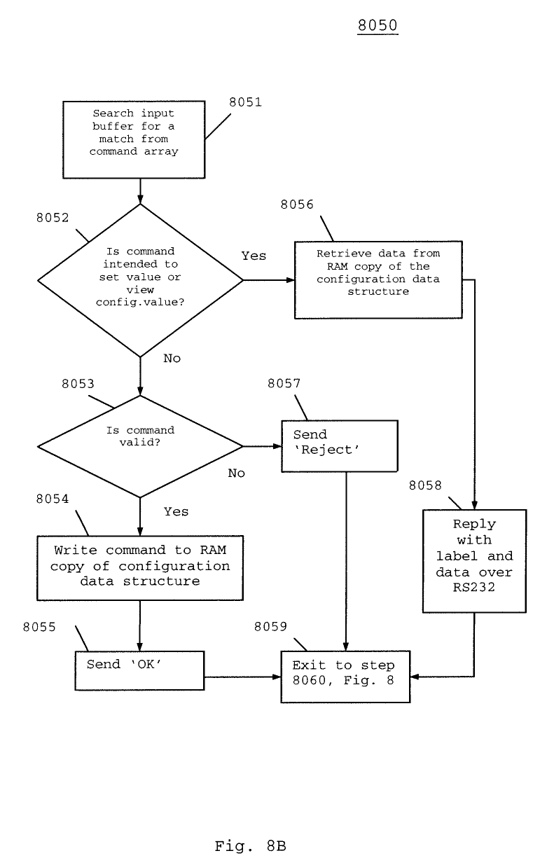

FIG. 8 is a basic application flowchart 8000 for the MPCRD application software. Upon system initialization, step 8010, all hardware, parameters, displays, ports, timers, etc. are initialized and then the application software will enter a 60 second tuning mode for the hardware setups, step 8020. Point 8030 is shown only as an application software return point. The application software will then check to see if the data buffer is full, step 8040. If ‘no’, the application software will move to process commands from the serial port, step 8050. Next in step 8060, the application software will update any direct attached or integrated display (LCD or other type) per the set configuration. The application software will allow any such display to have its configuration values selected and set from an attached keypad. Such values include, but are not limited to, the units (mph, kph, mps, fps), horizontal and vertical cosine angle, backlight, and sensitivity. It will then send outgoing messages via the serial port based on the system configuration protocol, step 8070. It will then monitor all internal power supplies, step 8080. If any voltage on the five power supplies is outside its limit, an error message is sent out via the rS232 port. Finally it will update the non-volatile configuration memory if required, step 8090 and then proceed back to point A, step 8030. In step 8090, if the RAM copy of the configuration is different from the flash memory copy a new copy is written to flash and the previous copy is invalidated. If the flash is full, the sector is erased and a copy of the contents of the RAM based configuration structure is placed to the first available location in the flash memory.

If the input buffer, as read from the ADC inputs, is full, step 8040 the application software will proceed to step 8100. In step 8100 the received Doppler signals from both channels are copied from the input buffer into a FFT buffer and are processed via a “Fast Fourier Transform” to calculate target speed. Next, in step 8120, the application software will track any existing target objects within MPCRD radar range. Next in step 8130, the application software will calculate the speed by converting FFT values from the object array positions to speed values and display selected parameters for any existing targets within range based on configuration parameters selected. Finally, in step 8140, the application software will track for any new target objects or remove any invalid target objects from the tracking array. As previously stated, targets may be vehicles, projectiles or a variety of objects. Typical interrupts for the application software include the following;
1. read radar ADC value into the left/right channel input buffers. This interrupt is critical to stabilization of the link between the DSP and its external analog to digital converters. If the input buffer FIFO is full, it indicates a disruption in the integrity of the ADC sampling and it is cleared. Also, if a frame sync error occurs, the input buffer is resynchronized before proceeding;
2. A CPU timer interrupt, typically running at about 50 Hz and re-synchronized with the analog to digital converted as required;
3. A process serial port interrupt to set a flag when <cr> is received, otherwise set to receive incoming data to the serial port buffer; and
4. A process serial port interrupt. If the buffer is not empty, copy from the transmit buffer to the peripheral buffer and kick off another interrupt.

FIG. 8A is a flow chart showing further details of FFT data processing and tracking from steps 8100, 8120, 8130 and 8140 as shown above in FIG. 8. Entry point ‘A’ is from the ‘yes’ output of step 8040 of FIG. 8. To begin the FFT data processing, in step 8102, the left channel input buffer is copied to a left channel temporary buffer. Next, in step 8104 the FFT is run on the left channel temporary buffer data. Then, in step 8106, array positions are located representing objects that are presently being tracked and theta (θ) is recorded for those objects. Theta will later be used to calculate the phase angle. Next, steps 8102, 8104, and 8106 are repeated for the right channel as shown in steps 8108, 8110, and 8112 again storing theta for later use. The temporary output of the FFT calculation for the right channel is then copied to an FFT output array buffer, in step 8114. In step 8116, the application loops through each of the objects and calculates the phase angle for each. The phase angle is the difference between the thetas and represents object direction, (going or coming, which are typically 90° apart. In step 8118, locate the fastest or strongest (user configurable parameter) target object in the FFT output array. Next, in step 8130 (ref. FIG. 8) the target object data is used to calculate speed and the display/hold (aforementioned user configuration parameter) determined for object speed display.

Steps 8142, through 8152 represent step 8140 of FIG. 8. In step 8142, the application software will find new and track any existing objects. Then, in step 8144, the frequency peak will be found using a combination of magnitude and slope factors. Peaks from the highest to lowest magnitudes are sorted. If the object tracking array is not full, step 8146, a return to step 8144 is initiated. If the object tracking array is full, then in step 8148, the application will go through the list of presently tracked objects and update the tracking parameters. Next, in step 8150, the temporary object array will be saved to an updated object array. Finally, in step 8152 the inherent radar noise floor is tracked for later reference and then a return to ‘A’ step 8030 of FIG. 8 completes the object FFT processing and tracking.

FIG. 8B is a flow chart of the ‘Process Commands’ step 8050 shown in FIG. 8. First, in step 8051, the input buffer is searched for a match from the valid command array. If the command is intended to set or view a configuration value (step 8052 query), then in step 8056, data is retrieved from the RAM copy of the configuration data structure, and in step 8058 a reply is sent with label data over the serial RS232 bus. Then the ‘process commands’ is exited in step 8059.

In step 8052 query, if the command is not intended to set a value or view a configuration value then the command is checked for validity, step 8053. If the command is not valid, a reject is sent, step 8057, over the RS232 bus. If the command is valid, then in step 8054, the command is written to the RAM copy of the configuration data structure and an ‘OK’ reply is sent over the RS232 bus, step 8055. Finally the ‘process commands’ is exited in step 8059.

An alternate embodiment of the present invention incorporates the ability to transmit two or more continuous frequencies to enable multiple target speeds and ranges to be specified. U.S. Pat. No. 6,798,374 filed Nov. 5, 2002 and titled ‘Traffic surveillance radar using ranging for accurate target identification’ and pending application Ser. No. 11/468,099 dated Aug. 29, 2006 and titled ‘Traffic Surveillance Radar Using Ranging For Accurate Target Identification’ are both incorporated herein by reference. Details are not shown herein but referenced to as this alternate embodiment can be incorporated for applications requiring multiple target real-time speed and range tracking.

Although the present invention has been described with reference to preferred embodiments, numerous modifications and variations can be made and still the result will come within the scope of the invention. No limitation with respect to the specific embodiments disclosed herein is intended or should be inferred. Each apparatus embodiment described herein has numerous equivalents.

We claim:

1. A programmable radar transceiver comprising:
a weatherproof housing for all components;
a Doppler signal transceiver;
a send/receive antenna;
a digital signal processor (DSP) which receives and processes Doppler signals from the Doppler signal transceiver;
wherein a speed and a direction of a target is calculated by the DSP;
an on board power regulator and power port for the programmable radar transceiver;
an input/output (I/O) communications port;
said DSP having a user programmable controller and having a data storage memory for target related data; and
wherein said user programmable controller receives from an external computer via the input/output communications port parameters including antenna type and frequency band selection, multiple I/O protocols, and custom event tracking storage parameters.

2. The apparatus of claim 1, wherein the antenna type parameters include horn lens and flat micro-strip array.

3. The apparatus of claim 2, wherein the antenna frequency band parameters include K-band and Kₐ-band.

4. The apparatus of claim 1, wherein the multiple I/O protocols include RS-232, RS-485, and CAN.

5. The apparatus of claim 1, wherein the Doppler signal transceiver and the DSP can calculate speed data for multiple targets simultaneously.

6. The apparatus of claim 1, wherein the DSP further comprises a programmable output display selection including units, tenths, hundredths and thousandths.

7. The apparatus of claim 1, wherein the DSP further comprises a programmable minimum speed output display.

8. The apparatus of claim 1, wherein the DSP further comprises a programmable speed selection range from zero to 600 miles per hour.

9. The apparatus of claim 1, wherein the DSP further comprises a programmable sign signal lock, wherein a displayed speed stays locked until the target speed varies beyond a programmable speed range.

10. The apparatus of claim 1 further comprising a roadside speed display sign connected to the I/O port.

11. The apparatus of claim 10 further comprising a speaker which is driven by an audio output signal from the DSP.

12. The apparatus of claim 1 further comprising a speaker which is driven by an audio output signal from the DSP.

13. The apparatus of claim 1, wherein the DSP further comprises a real time clock to provide time based event tracking with the custom event tracking storage parameters.

14. A programmable radar transceiver comprising:
a weatherproof housing for all components;
a Doppler signal transceiver;
a send/receive antenna;
a digital signal processor (DSP) which receives and processes Doppler signals from the Doppler signal transceiver;
wherein a speed and a direction of a target is calculated by the DSP;
an on board power regulator and power port for the programmable radar transceiver;
an input/output (I/O) communications port;
said DSP having and a user programmable controller and having a data storage memory for target related data; and
wherein said send/receive antenna is a micro-strip array providing a flat exterior front surface for the weatherproof housing.

15. The apparatus of claim 14, wherein the DSP has a real time clock and the programmable controller receives from an external computer via the I/O communications port parameters including custom time base event tracking storage data.

16. The apparatus of claim 14, wherein the Doppler signal transceiver and the DSP can calculate speed data for multiple targets simultaneously.

17. A programmable radar transceiver comprising:
a weatherproof housing for all components;
a Doppler signal transceiver;
a send/receive antenna;
a digital signal processor (DSP) which receives and processes Doppler signals from the Doppler signal transceiver;
wherein a speed and a direction of a target is calculated by the DSP;
an on board power regulator and power port for the programmable radar transceiver;
an input/output (I/O) communications port;
said DSP having a user programmable controller and having a data storage memory for target related data;
a roadside sign connected to the I/O communications port; and
wherein a DSP audio signal drives a speaker.

18. The apparatus of claim 17, wherein the DSP has a real time clock and the programmable controller receives from an external computer via the I/O communications port parameters including custom time based event tracking storage data.

19. The apparatus of claim 17, wherein the Doppler signal transceiver and the DSP can calculate speed data for multiple targets simultaneously.

20. The apparatus of claim 17, wherein the programmable controller accepts parameters for a plurality of antenna frequency bands.

21. The apparatus of claim 17, wherein the programmable controller accepts parameters for a plurality of I/O protocols.
